(19) United States
(12) Patent Application Publication
(10) Pub. No.: US 2026/0227130 A1
(43) Pub. Date: Aug. 6, 2026

(54) ROTARY SEAL FOR A HIGH-TEMPERATURE ROTARY KILN

(71) Applicant: Redwood Materials, Inc., Carson City, NV (US)

(72) Inventor: Michael Jan Rodzinski, Reno, NV (US)

(21) Appl. No.: 19/178,539

(22) Filed: Apr. 14, 2025

Related U.S. Application Data
(60) Provisional application No. 63/752,491, filed on Jan. 31, 2025.

(51) Int. Cl. F27B 7/24; F16J 15/3284

(52) U.S. Cl. CPC F27B 7/24; F16J 15/3284

(57) ABSTRACT

The present disclosure relates to systems, devices, and methods for sealing a rotary kiln. In particular, in one or more embodiments, the disclosed systems provide a seal assembly for a high-temperature rotary kiln. For example, in some embodiments, the seal assembly comprises a seal rotor couplable to the high-temperature rotary kiln such that the seal rotor is configured to rotate with the high-temperature rotary kiln. In addition, in some implementations, the seal assembly comprises a seal housing comprising a seal configured to interface with the seal rotor on an external-facing side of the seal rotor such that an internal-facing side of the seal rotor is free of seal component interfaces.

### RELATED APPLICATIONS

This application claims priority to and the benefit of United States Provisional Patent Application No. 63/752,491, filed on January 31, 2025 and titled “ROTARY SEAL FOR A HIGH-TEMPERATURE ROTARY KILN,” the contents of which are hereby incorporated by reference herein in their entirety.

### BACKGROUND

Rotary kilns are often used in various manufacturing and other industrial applications. For instance, a rotary kiln can be used to mix, stir, and heat constituent materials to a high temperature. Despite advances in rotary kiln technology in various fields of use, existing systems for rotary kilns face several shortcomings. In particular, existing systems for rotary kilns have deficiencies with regard to sealing mechanisms to seal a rotary kiln to reduce leakage of gases, fluids, and/or materials at an interface between a rotating component of the kiln and a stationary component of the kiln.

These along with additional problems and issues exist with regard to conventional systems for constructing and using a rotary kiln.

### BRIEF SUMMARY

Embodiments of the present disclosure provide benefits and/or solve one or more of the foregoing or other problems in the art with systems, devices, and methods for sealing a rotary kiln. To illustrate, in some embodiments, the disclosed systems provide a seal assembly for a high-temperature rotary kiln. For example, in some implementations, the disclosed systems include a seal rotor configured to be coupled to a rotary kiln so as to rotate with the rotary kiln. Additionally, in some implementations, the disclosed systems include a seal housing that interfaces with the seal rotor on an external-facing side of the seal rotor and provides a seal for the rotary kiln. Moreover, in some embodiments, the seal rotor is free of seal component interfaces on an internal-facing side of the seal rotor.

The following description sets forth additional features and advantages of one or more embodiments of the disclosed systems, devices, and methods. In some cases, such features and advantages are evident to a skilled artisan having the benefit of this disclosure, or may be learned by the practice of the disclosed embodiments.

### BRIEF DESCRIPTION OF THE DRAWINGS

The detailed description provides one or more embodiments with additional specificity and detail through the use of the accompanying drawings, as briefly described below.

FIGS. 1A and 1B illustrate a perspective view and a perspective cutaway view, respectively, of a rotary kiln with a seal assembly in accordance with one or more embodiments.

FIG. 2 illustrates a perspective section view of some of the components of the seal assembly coupled to the rotary kiln in accordance with one or more embodiments.

FIG. 3 illustrates a perspective view of the rotary kiln with an alignment collar attached to the shell of the rotary kiln in accordance with one or more embodiments.

FIG. 4 illustrates a perspective section view of some of the components of the seal assembly coupled to the rotary kiln in accordance with one or more embodiments.

FIG. 5 illustrates a section view of the seal assembly coupled to the rotary kiln in accordance with one or more embodiments.

FIGS. 6A and 6B illustrate section views of the seal assembly coupled to the rotary kiln in accordance with one or more embodiments.

FIG. 7 illustrates a section view of the seal assembly coupled to the rotary kiln in accordance with one or more embodiments.

### DETAILED DESCRIPTION

This disclosure describes one or more embodiments of systems, devices, and methods for sealing a rotary kiln. In some embodiments, a seal assembly for a rotary kiln includes a seal rotor and a seal housing that interfaces with the seal rotor on a single side of the seal rotor such that an opposite side of the seal rotor is free of seal component interfaces. Additionally, in some implementations, the seal housing houses one or more seals to interface with the seal rotor. For example, a pair of rope seals are seated in the seal housing to press against the seal rotor and maintain a seal interface with the seal rotor.

In addition, in some embodiments, the seal assembly includes a track roller channel coupled to the seal rotor. The track roller channel interfaces with a track roller coupled to the seal housing. As the seal rotor moves axially (e.g., due to thermal expansion of the rotary kiln), the track roller travels with the track roller channel to maintain a sealing interface between the seal housing and the seal rotor.

Moreover, in various embodiments, the rotary kiln operates at a high temperature and/or a high oxygen concentration. To operate in these environmental conditions, in one or more embodiments, the materials and design of the seal assembly are such that the seal assembly can withstand high temperatures and an oxygen-rich environment. For example, in some embodiments, the seals are flexible graphite-based rope seals that survive high temperatures without igniting. Additionally, in some embodiments, the seal assembly includes a stream of carbon-free air that maintains a positive pressure differential between the seal and a chamber of the rotary kiln, thereby forcing the oxygen rich gasses of the rotary kiln to remain in the chamber.

Furthermore, and as discussed throughout this disclosure, the seal assembly provides several advantages over conventional systems, including providing enhanced maintenance access to the seal(s) and seal rotor of the seal assembly, mitigating potential internal ignition sources in the chamber of the rotary kiln, and providing a path for material drop out to reduce the chance of contaminating the materials fired in the kiln or of degrading the seal components.

The components of the embodiments as generally described and illustrated in the figures herein can be arranged and designed in a wide variety of different configurations. Thus, the following more detailed description of various embodiments, as represented in the figures, is not intended to limit the scope of the present disclosure, but is merely representative of various embodiments.

As used herein, the terms “coupled to” and “couplable to” are broad enough to refer to any suitable coupling or other form of interaction between two or more entities, including mechanical interaction. Thus, two components may be coupled to each other even though they are not in direct contact with each other. The phrase “attached to” refers to interaction between two or more entities which are in direct contact with each other and/or are separated from each other only by a fastener of any suitable variety (e.g., mounting hardware or an adhesive).

As used herein, the term “substantially,” in reference to a given parameter, property, or condition, means to a degree that one of ordinary skill in the art would understand that the given parameter, property, or condition is met within a degree of variance, such as within acceptable manufacturing tolerances. By way of example, depending on the particular parameter, property, or condition that is substantially met, the parameter, property, or condition may be at least 70.0% met, at least 80.0%, at least 90.0% met, at least 95.0% met, at least 99.0% met, at least 99.9% met, or even 100% met.

As used herein, the terms “about” and “approximately,” when used in conjunction with numerical values and/or ranges, generally refer to those numerical values and/or ranges near to a recited numerical value and/or range. In some instances, the terms “about” and “approximately” may mean within ± 10% of the recited value. For example, in some instances, “about 100 [units]” may mean within ± 10% of 100 (e.g., from 90 to 110). The terms “about” and “approximately” may be used interchangeably.

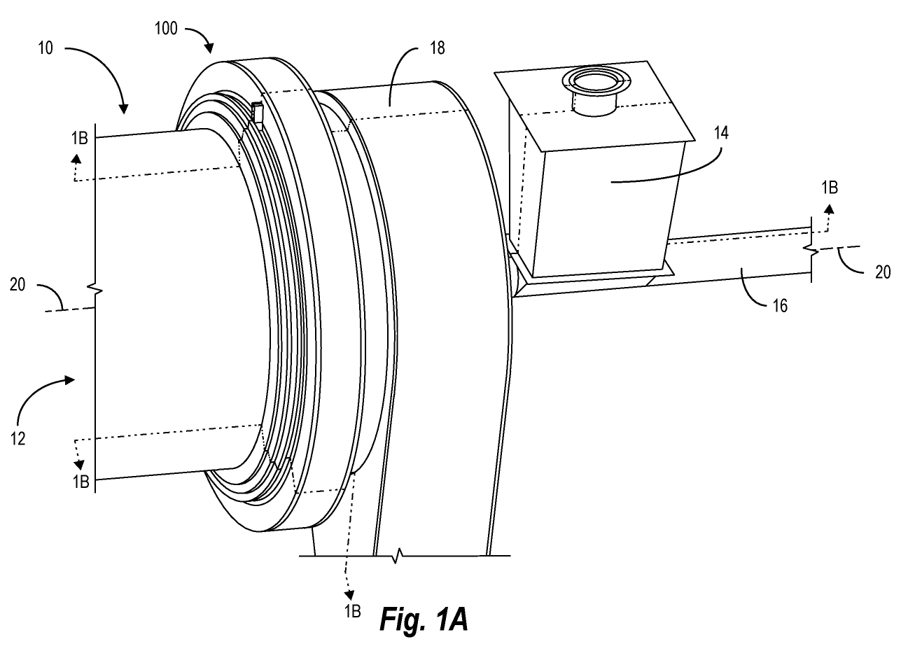

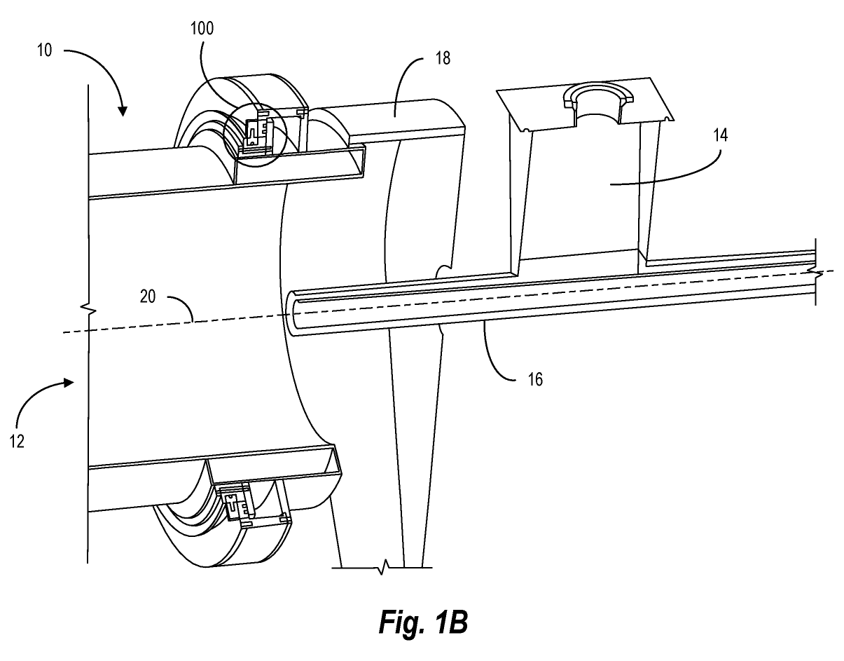

Additional detail will now be provided in relation to illustrative figures portraying example embodiments and implementations of the disclosed systems. For instance, FIGS. 1A and 1B illustrate a perspective view and a perspective cutaway view, respectively, of a rotary kiln 10 with a seal assembly 100 according to one or more embodiments. In particular, FIG. 1A shows the rotary kiln 10 with a body (e.g., a shell) that defines a chamber 12 in which various materials can be mixed and/or heated to a high temperature.

Moreover, the rotary kiln 10 can rotate around an axis of rotation 20. As used herein, axial movement is movement parallel to the axis of rotation 20. Radial movement is movement perpendicular to the axis of rotation 20. Circumferential movement is movement around the axis of rotation 20. The rotary kiln 10, seal assembly 100, and other components described herein can undergo various types of movement. For example, regular rotation of the rotary kiln 10 is circumferential movement. As discussed below, the rotary kiln 10 and the seal assembly 100 can undergo axial movement. Moreover, the rotary kiln 10 and the seal assembly 100 can undergo radial movement. In some cases, the rotary kiln 10 can undergo radial movement with respect to the seal assembly 100. For example, the rotary kiln 10 can move radially while the seal assembly 10 may remain stationary. As described in additional detail below, the seal assembly 100 can maintain a seal for the rotary kiln 10 notwithstanding axial and/or radial movement of the shell of the rotary kiln 10.

As also shown in FIG. 1A, a hopper 14 and a feed line 16 can be used to add material to the chamber 12. Moreover, the rotary kiln 10 includes an end cap 18 to enclose the chamber 12. While the body of the rotary kiln 10 can rotate around the axis of rotation 20, the end cap 18 is a stationary component. As explained in detail below, the seal assembly 100 provides an interface between the rotating component (the kiln shell) and the stationary component (the end cap 18) that helps to keep gas and materials in the kiln while lubricating the rotary interface.

FIG. 1A also shows section lines representing cutaway portions of the rotary kiln 10 and seal assembly 100 for the view of FIG. 1B. As shown in FIG. 1B, the feed line 16 can feed material from the hopper 14 through the end cap 18 to the chamber 12 of the rotary kiln 10. Moreover, the seal assembly 100 includes various components that are shown in the subsequent figures and described with additional detail below.

As mentioned, in some implementations, the rotary kiln 10 is used to mix and heat materials at a high temperature and in an oxygen enriched environment. For example, in some implementations, the rotary kiln 10 heats and mixes materials for manufacturing batteries. To illustrate, in a pre-centering process of one or more embodiments, a precursor material (e.g., material comprising various elements, such as nickel, manganese, and/or aluminum components) is combined with lithium in the chamber 12 of the rotary kiln 10. The precursor and lithium are heated at high temperature in an oxygen-rich environment to make cathode active material (CAM) for lithium-ion batteries.

In some additional implementations, the rotary kiln 10 is used in a coating process. For example, a protective coating is added to the CAM in the chamber 12 of the rotary kiln 10. To illustrate, a metal oxide is mixed and heated with the CAM to apply a protective layer to the surface of the CAM. Furthermore, the rotary kiln 10 can be used in a variety of other applications, including manufacturing and/or recycling of materials.

As described with additional detail below, the components of the seal assembly 100 can safely withstand the high-temperature and high-oxygen content environment of the rotary kiln 10. For example, in some embodiments, the seals used in the seal assembly 100 are graphite-based seals that are rated to high temperatures. Moreover, and as described below, in some embodiments, the seal assembly 100 prevents or otherwise mitigates the possibility of ignition of the seal components.

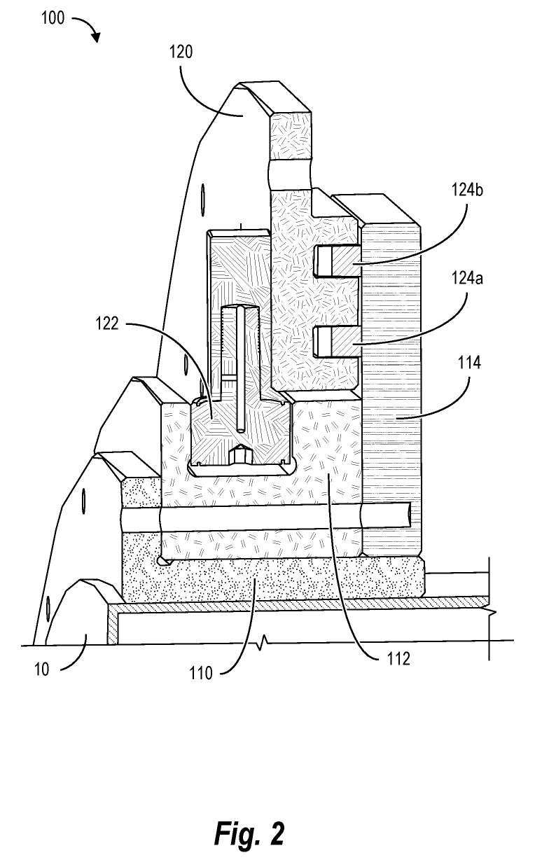

FIG. 2 illustrates a perspective section view of some of the components of the seal assembly 100 coupled to the rotary kiln 10 in accordance with one or more embodiments. Various components shown are illustrated with section hatching to show internal surfaces exposed by cutaways of the section view. In particular, FIG. 2 shows a collar 110 (e.g., an alignment collar) attached to the shell of the rotary kiln 10. For instance, the collar 110 can be welded to the shell of the rotary kiln 10 to secure the collar 110 at a fixed position on the rotary kiln 10.

Additionally, FIG. 2 shows a track roller channel 112 positioned on the collar 110. For example, the track roller channel 112 is couplable to the collar 110 (e.g., via a set of screws) to secure the track roller channel 112 to the rotary kiln 10. Furthermore, as shown, a seal rotor 114 is also positioned on the collar 110. For example, the seal rotor 114 is couplable to the track roller channel 112 and the collar 110 (e.g., via the set of screws). With the collar 110 attached (e.g., welded) to the shell of the rotary kiln 10, and with the track roller channel 112 and the seal rotor 114 coupled (e.g., fastened via screws) to the collar 110, the track roller channel 112 and the seal rotor 114 can rotate with the body of the rotary kiln 10 (around the axis of rotation 20 shown in FIGS. 1A and 1B).

As also shown in FIG. 2, a seal housing 120 interfaces with the seal rotor 114. More particularly, the seal housing includes one or more seals that contact the seal rotor 114. For example, FIG. 2 shows a first seal 124a and a second seal 124b in the seal housing 120. The first seal 124a and the second seal 124b slidably interface with a surface of the seal rotor 114. For example, the seals 124a, 124b interface with the seal rotor 114 on an external-facing side (e.g., away from the inside of the chamber of the rotary kiln 10) of the seal rotor 114.

Furthermore, FIG. 2 shows a track roller 122 seated in the track roller channel 112. As also shown, the track roller 122 is coupled to the seal housing 120. The track roller 122 together with the track roller channel 112 can help maintain a relative position of the seal housing 120 with respect to the seal rotor 114. For example, as the shell of the rotary kiln 10 expands (e.g., due to increased temperature), the seal rotor 114 moves in an axial direction. As the seal rotor 114 moves, the track roller channel 112 also moves (e.g., a corresponding axial movement). As the track roller 122 is seated in the track roller channel 112, the track roller 122 moves in tandem with the track roller channel 112. Thus, the track roller 122 transfers an axial load from the rotary kiln 10 (through the track roller channel 112 and the track roller 122) to the seal housing 120, thereby causing the seal housing 120 to likewise move axially. This corresponding axial movement of the seal housing 120 with respect to the seal rotor 114 helps to maintain the sealing interface of the seals 124a, 124b with the seal rotor 114.

In some embodiments, the seal assembly 100 includes multiple track rollers 122 in communication with the track roller channel 112. For example, in some embodiments, the seal assembly 100 has three track rollers 122 to support the seal housing 120 circumferentially around the track roller channel 112. In alternative embodiments, the seal assembly 100 uses a different number (e.g., two, four, five, or more) of track rollers 122. In some embodiments, the seal assembly 100 uses crowned rollers in the track roller channel 112.

Moreover, in some implementations, as the track rollers 122 transfer an axial load from the track roller channel 112 to the seal housing 120, the seal housing 120 applies an asymmetric loading on the seal rotor 114. For example, the axial load on the seal rotor 114 comes from the external-facing side. This configuration has the advantage that internal wear blocks (e.g., brass or carbon blocks against the rotor) are not necessary. For instance, conventional seal systems that use internal wear blocks rely on balanced seal forces from both sides of the rotor to self-align. By contrast, the seal housing 120 provides an asymmetric loading on the seal rotor 114 and thus maintains the seal.

In addition to withstanding axial movements, in some embodiments, the seal assembly 100 can withstand radial movements. For example, if the shell of the rotary kiln 10 is jostled in a radial direction, the seal rotor 114 can slide against the seals 124a, 124b without breaking the sealing interface of the seals 124a, 124b. In other words, the seal assembly 100 flexibly accommodates both radial and axial movement of the shell of the rotary kiln 10 while maintaining the sealing interface.

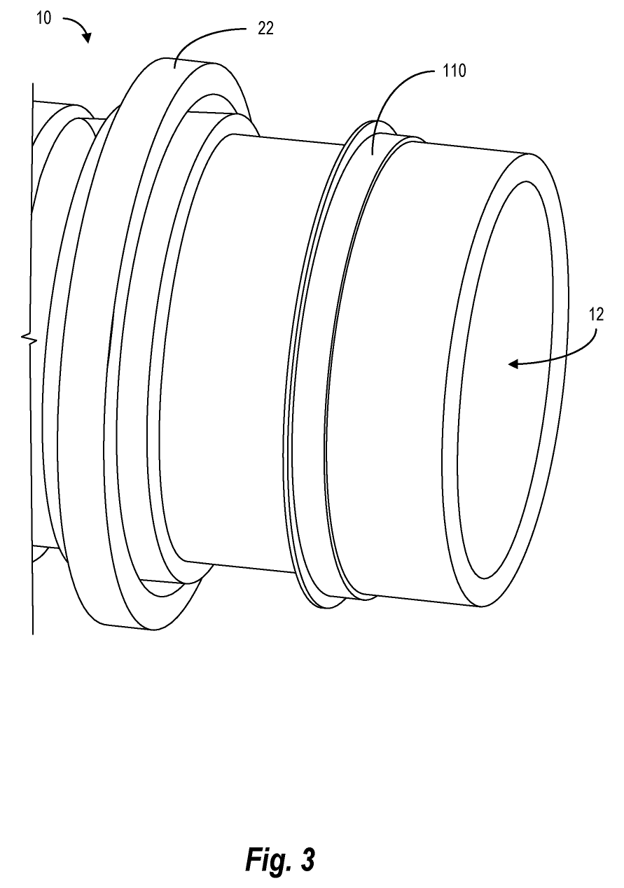

FIG. 3 illustrates a perspective view of the rotary kiln 10 with the collar 110 attached to the shell of the rotary kiln 10 in accordance with one or more embodiments. In some embodiments, the collar 110 is configured to be attached to the rotary kiln shell via any suitable means, such as by welding. As mentioned above, the seal rotor 114 and the track roller channel 112 can be coupled to the collar 110 (e.g., via fasteners, such as screws). Thus, the seal rotor 114 and the track roller channel 112 can be coupled to the shell of the rotary kiln 10 through the collar 110. Thus, the collar 110, the track roller channel 112, and the seal rotor 114 can rotate with the shell of the rotary kiln 10 around the axis of rotation 20.

Additionally, FIG. 3 shows a tyre or riding ring 22 of the rotary kiln 10. In one or more embodiments, the riding ring 22 helps to support the weight of the rotary kiln 10 on a set of rollers. For example, the riding ring 22 helps to support the shell of the rotary kiln 10 and turn the shell of the rotary kiln 10 around the axis of rotation 20.

In some embodiments, a first portion of the seal assembly 100 is installed on the rotary kiln 10 as follows: the shell of the rotary kiln 10 is installed by aligning the riding ring 22 on a set of rollers; an axial position of the shell is verified with respect to breach and seal target datums (e.g., the seal assembly 100 and the end cap 18); and the collar is welded to the shell of the rotary kiln 10. Moreover, radial and axial surfaces of the collar 110 can be machined to improve the interface of the collar 110 with the other seal assembly components.

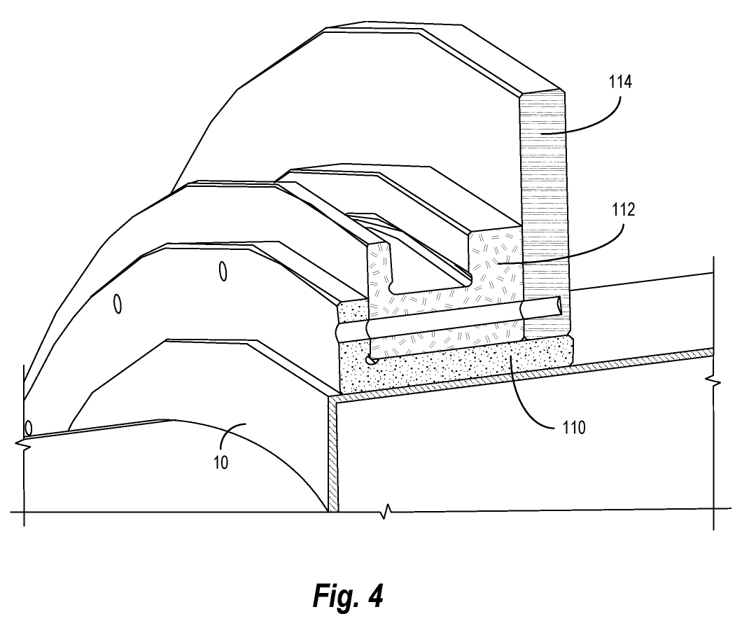

FIG. 4 illustrates a perspective section view of some of the components of the seal assembly 100 coupled to the rotary kiln 10 in accordance with one or more embodiments. Various components shown are illustrated with section hatching to show internal surfaces exposed by cutaways of the section view. In particular, FIG. 4 shows the collar 110 attached to the shell of the rotary kiln 10, with the track roller channel 112 and the seal rotor 114 coupled to the collar 110. For example, a set of screws or other fasteners can be used to fasten the track roller channel 112 and the seal rotor 114 to the collar 110 through a set of screw holes. Thus, the seal rotor 114 and the track roller channel 112 can also be coupled to the shell of the rotary kiln 10 (through the collar 110). Alternatively, the track roller channel 112 and the seal rotor 114 can be coupled to the collar 110 in other ways, such as via welding.

In some embodiments, a second portion of the seal assembly 100 is installed on the rotary kiln 10 as follows: the track roller channel 112 is placed over the alignment collar 110; the seal rotor 114 is placed over the alignment collar 110; and the alignment collar 110, the track roller channel 112, and the seal rotor 114 are coupled by fastening a set of screws through each piece. For example, the alignment collar 110 has a set of through holes, the track roller channel 112 has a corresponding set of through holes, and the seal rotor 114 has a corresponding set of threaded blind holes.

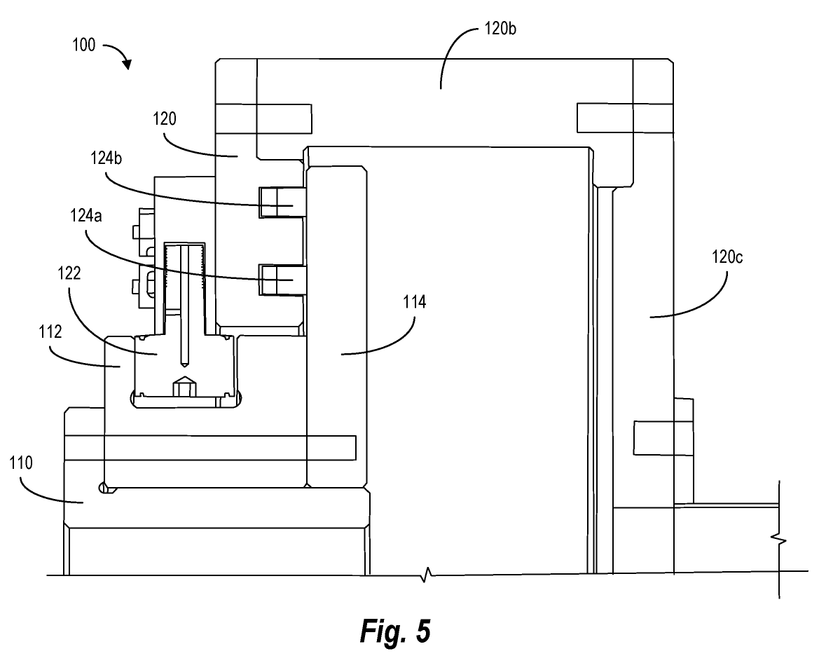

FIG. 5 is a section view of the seal assembly 100 coupled to the rotary kiln 10 in accordance with one or more embodiments. While the components of the seal assembly 100 are shown in section view in FIG. 5, section hatching lines are omitted for clarity. In particular, FIG. 5 shows the collar 110, the track roller channel 112, and the seal rotor 114 coupled to each other and to the rotary kiln 10. As mentioned, the collar 110, the track roller channel 112, and the seal rotor 114, when coupled to the rotary kiln 10, move with the rotary kiln 10 rotationally around the axis of rotation 20 of the rotary kiln 10.

Additionally, FIG. 5 shows the track roller 122 and the seal housing 120 coupled to each other and interfacing, respectively, with the track roller channel 112 and the seal rotor 114. For example, the track roller 122 is seated in a channel portion of the track roller channel 112 to allow the track roller channel 112 to roll circumferentially around the axis of rotation 20 while the track roller 122 remains in a fixed circumferential position. Moreover, the track roller 122 is coupled (e.g., via fasteners, such as screws) to the seal housing 120.

In some embodiments, the seal housing 120 has a single seal that interfaces with the seal rotor 114. For example, the seal housing 120 presses the seal against the seal rotor 114 with a sealing pressure to maintain a seal between the chamber of the rotary kiln 10 and the ambient atmosphere outside of the rotary kiln 10. In some other embodiments, the seal housing 120 has two seals (e.g., the first seal 124a and the second seal 124b) that interface with the seal rotor 114. For example, the seal housing 120 presses the first seal 124a and the second seal 124b against the seal rotor 114 with a sealing pressure to maintain the seal between the chamber of the rotary kiln 10 and the ambient atmosphere outside of the rotary kiln 10. In some alternative embodiments, the seal housing 120 has three or more seals that interface with the seal rotor 114.

Moreover, in some implementations, the seals in the seal housing 120 are compression packing, such as rope seals. A rope seal includes a compression packing (e.g., in the shape of a rope) that can be applied to a joint between two surfaces to prevent or otherwise mitigate leakage of a fluid between the two surfaces. For example, a rope seal includes a flexible graphite packing. In one or more embodiments, the first seal 124a is a first rope seal, and the second seal 124b is a second rope seal. In some embodiments, the rope seals are square-profile rope seals, while in other embodiments, the rope seals are round-profile rope seals. Furthermore, in certain embodiments, the seals 124a, 124b comprise a non-metal material (e.g., a polymer such as PTFE, a flexible graphite yarn, silica, fiberglass, etc.) to avoid or otherwise mitigate metal-on-metal contact between sliding surfaces of the seal assembly 100.

In some implementations, the seals 124a, 124b are high-temperature rope seals. For example, the seals 124a, 124b are configured to withstand high operating temperatures. For example, in some embodiments, the seals 124a, 124b are configured to withstand an operating temperature in the range of 200 to 250 degrees Celsius. Furthermore, in some embodiments, the seals 124a, 124b are configured to withstand an operating temperature of up to 450 degrees Celsius. In certain embodiments, the seals 124a, 124b are configured to withstand an operating temperature of up to 1260 degrees Celsius. In some embodiments, the seals 124a, 124b are configured to withstand an operating temperature of up to 2000 degrees Celsius.

Relatedly, in some implementations, the seals 124a, 124b are configured to withstand an oxygen-rich environment of the rotary kiln 10. To illustrate, in one or more embodiments, the seals 124a, 124b are made of materials that have a high oxygen service rating. For example, the seals 124a, 124b can withstand an oxygen index of up to 100 percent. For instance, the seals 124a, 124b keep friction between the seal housing 120 and the seal rotor 114 low while minimizing or otherwise mitigating a risk of ignition in the high oxygen environment.

As mentioned, in some embodiments, the seals in the seal housing 120 are configured to interface with the seal rotor 114 on a single side of the seal rotor 114. For example, the first seal 124a and the second seal 124b each interface with the seal rotor 114 on an external-facing side of the seal rotor 114. Furthermore, in some embodiments, the internal-facing side (e.g., the side in fluid communication with the chamber of the rotary kiln 10) of the seal rotor 114 is free of seal component interfaces. To illustrate, and as shown in FIG. 5, the seal rotor 114 contacts the first seal 124a and the second seal 124b on a first side (the external-facing side) and is free of seal component interfaces on a second side (the internal-facing side).

As also mentioned, by configuring the seal(s) on the external-facing side of the seal rotor 114, the seal assembly 100 provides several advantages over conventional seal systems. For instance, the seal housing 120 and the seal(s) are accessible for maintenance on the external-facing side of the seal rotor 114 without decoupling the seal rotor 114 from the rotary kiln 10. To elaborate, the first seal 124a and the second seal 124b can be serviced by separating the seal housing 120 from the seal rotor 114 without repositioning the seal rotor 114 or separating the seal rotor 114 from the collar 110. Thus, the configuration of the seal assembly 100 provides streamlined maintenance access over conventional systems.

Additionally, by configuring the seal(s) on the external-facing side of the seal rotor 114, the seal assembly 100 mitigates potential material buildup on the internal-facing side of the seal rotor 114 and consequent potential degradation of the seals. For example, some conventional systems include seal component interfaces on an internal-facing side of a seal rotor, which can collect materials that fall from the chamber of the rotary kiln 10. The buildup of such material and debris causes wearing of the seals, thereby shortening the service life of the seals and increasing the need for maintenance. By contrast, in one or more embodiments, the seal assembly 100 avoids this problem by interfacing the seal rotor 114 with seal component interfaces (e.g., the seals 124a, 124b) only on the external-facing side of the seal rotor 114. As another example, if the seals 124a, 124b wear down during use, seal material will generally drop out on the external-facing side of the seal rotor 114, rather than on the internal-facing side, thereby maintaining a cleaner environment inside the rotary kiln 10.

Furthermore, by configuring the seal(s) on the external-facing side of the seal rotor 114, the seal assembly 100 improves heat management over conventional systems. For example, the seal housing 120 can eject heat to the ambient surroundings better because the sealing interfaces are on a single (outer) face of the seal rotor 114.

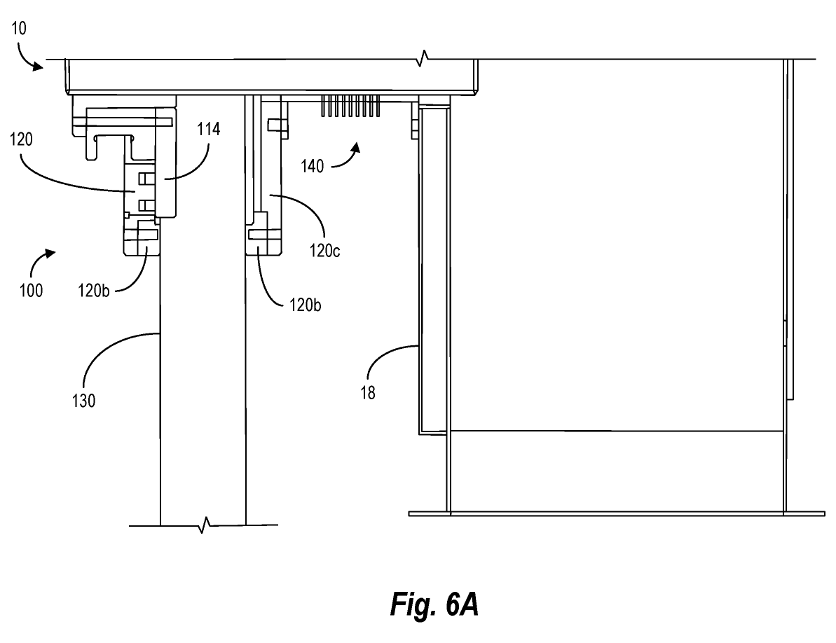

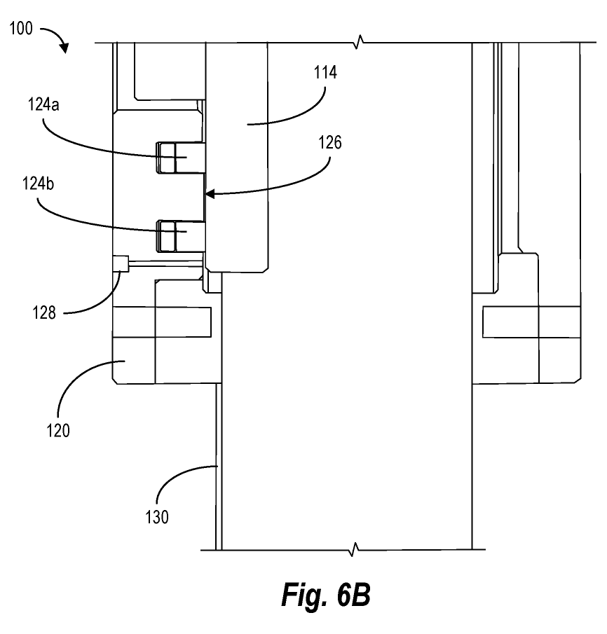

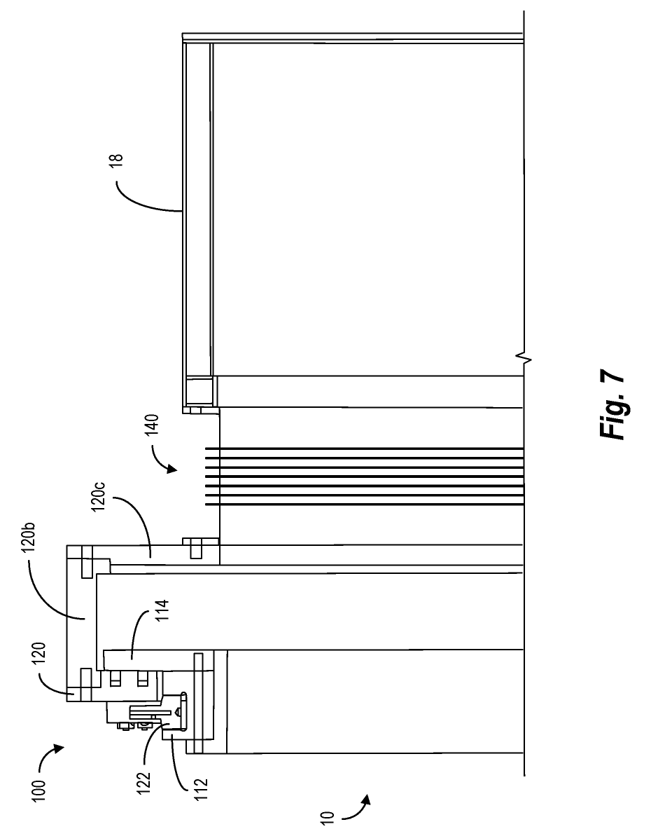

As also shown in FIG. 5, in one or more embodiments, the seal assembly 100 includes additional housing components to interface with the rotary kiln 10. For example, the seal housing 120 is couplable to the end cap of the rotary kiln 10 via a first intermediate housing 120b and a second intermediate housing 120c. To illustrate, the seal housing 120 can be fastened (e.g., via screws) to the first intermediate housing 120b. Additionally, the first intermediate housing 120b can be fastened (e.g., via screws) to the second intermediate housing 120c. The interface of the seal housing 120 with the end cap of the rotary kiln 10 is shown in additional detail in FIGS. 6A and 7.

In some embodiments, a third portion of the seal assembly 100 is installed on the rotary kiln 10 as follows: the track roller(s) 122 and the seal housing 120 are placed over the shell of the rotary kiln 10; the seals 124a, 124b are placed in the seal housing 120; and the track roller(s) 122 are placed into the track roller channel 112 and coupled (e.g., fastened) to the seal housing 120 to press the seals 124a, 124b against the seal rotor 114. In one or more embodiments, the seal housing 120 is coupled to the end cap of the rotary kiln 10 by fastening the seal housing 120 to one or more intermediate housings and by fastening the one or more intermediate housings to the end cap of the rotary kiln 10.

FIGS. 6A and 6B illustrate section views of the seal assembly 100 coupled to the rotary kiln 10 in accordance with one or more embodiments. While the components of the seal assembly 100 are shown in section view in FIGS. 6A and 6B, section hatching lines are omitted for clarity. Moreover, FIGS. 6A and 6B show an underside portion of the seal assembly 100. In particular, FIG. 6A shows a material collection bin 130 beneath the seal rotor 114 and the seal housing 120. In some embodiments, the material collection bin 130 captures drop out material from the rotary kiln 10, the seal rotor 114, and/or the seal housing 120. For instance, as mentioned above, if the seals 124a, 124b wear down during use, seal material will generally drop out on the external-facing side of the seal rotor 114. Furthermore, if material in the chamber of the rotary kiln 10 falls out of the chamber, the material can be collected in the material collection bin 130. The drop out material can be collected in the material collection bin 130 for removal from the rotary kiln 10, thereby reducing the incidence of foreign material inside the chamber of the rotary kiln 10 and/or the seal assembly 100.

In addition, FIG. 6A shows an expansion joint 140. The expansion joint 140 can help maintain the seal interface between the seal housing 120 and the seal rotor 114 as the rotary kiln 10 expands due to thermal gradients. Additionally, the seal housing 120 can be coupled to the expansion joint 140 through the first intermediate housing 120b and the second intermediate housing 120c. Moreover, the expansion joint 140 can be coupled to the end cap 18 of the rotary kiln 10. As mentioned, in some implementations, the housing components (e.g., the seal housing 120, the first and second intermediate housings 120b, 120c, and the expansion joint 140) remain circumferentially stationary with the end cap 18 of the rotary kiln 10. Further detail of the expansion joint 140 is given below in connection with FIG. 7.

FIG. 6B shows a close-up view of portions of the seal assembly 100 that are shown in FIG. 6A. In particular, FIG. 6B shows the seal rotor 114 interfacing with the first seal 124a and the second seal 124b of the seal housing 120. Additionally, FIG. 6B shows a fluid port 128 in the seal housing 120. In some embodiments, one or more fluid ports 128 are included in the seal housing 120. The fluid port(s) 128 is configured to allow a fluid jet to pass through the seal housing 120 onto the seal rotor 114. For example, a hose can be connected to the fluid port 128 to pass a jet of fluid (e.g., a static jet of carbon-free air) onto the seal rotor 114.

In some embodiments, the fluid jet on the seal rotor 114 clears tramp material or other debris from the seal rotor. For example, if material builds up on the seal rotor 114 (e.g., from wear of the seals 124a, 124b), the fluid jet can press the debris off of the seal rotor 114 to move away from the seal housing 120 and drop away from the seal assembly 100 to collect in the material collection bin 130. Additionally, the fluid jet can provide cooling for the seal rotor 114 by increasing a rate of convection heat transfer from the seal rotor 114. Moreover, the fluid jet can reduce an oxygen concentration near the sealing interfaces to mitigate potential ignition sources near the seals.

Moreover, FIG. 6B shows a gap 126 between the first seal 124a and the second seal 124b. In some embodiments, the fluid jet passed through the fluid port 128 creates a pressure differential between the gap 126 and the chamber of the rotary kiln 10. The pressure differential can form a fluid seal purge for the seal assembly 100. For example, a relatively high pressure in the gap 126 (as compared to the pressure in the chamber of the rotary kiln 10) can limit the passage of fluids or other material in the rotary kiln 10 through the seal assembly 100 to the ambient environment. Moreover, if fluid does leak to the ambient environment, the fluid jet can help ensure that the leak will contain carbon-free air to mitigate risk of ignition. Similarly, a relatively high pressure in the gap 126 (as compared to the ambient pressure outside of the rotary kiln 10) can limit passage of ambient air or external debris into the rotary kiln 10.

FIG. 7 illustrates a section view of the seal assembly 100 coupled to the rotary kiln 10 in accordance with one or more embodiments. While the components of the seal assembly 100 are shown in section view in FIG. 7, section hatching lines are omitted for clarity. In particular, FIG. 7 shows an expansion joint 140 coupled to the seal housing 120. For example, the seal housing 120 is coupled (e.g., fastened) to the first intermediate housing 120b, which is likewise coupled (e.g., fastened) to the second intermediate housing 120c. Additionally, the second intermediate housing 120c is coupled (e.g., fastened) to the expansion joint 140. Moreover, the expansion joint 140 is coupled (e.g., fastened) to the end cap 18 of the rotary kiln 10.

The expansion joint 140 can help maintain the seal interface between the seal housing 120 and the seal rotor 114 as the rotary kiln 10 expands or contracts due to thermal gradients. Additionally, the expansion joint 140 can mitigate potential interference between the shell of the rotary kiln 10 and the end cap 18. For instance, the expansion joint 140 is configured to expand and contract in an axial direction (a left-right direction in the view of FIG. 7). In this way, the expansion joint 140 accommodates thermal expansion and contraction of the shell and/or other components of the rotary kiln 10.

Moreover, as discussed above, the track roller channel 112 can transfer an axial load from the shell of the rotary kiln 10 through the track roller 122 to the seal housing 120 to maintain a sealing force of the seal(s) against the seal rotor 114. Thus, the seal assembly 100 can maintain a seal between the rotary kiln 10 and the stationary end cap 18 notwithstanding thermal expansion of the rotary kiln 10.

In some embodiments, a fourth portion of the seal assembly 100 is installed on the rotary kiln 10 as follows: an expansion joint mounting plate (e.g., the second intermediate housing 120c) is coupled to the seal housing 120 (e.g., via the first intermediate housing 120b); the expansion joint 140 is coupled to the expansion joint mounting plate; and the end cap 18 of the rotary kiln 10 is coupled to the expansion joint 140.

### EXAMPLES

The following are some example embodiments within the scope of the disclosure. In order to avoid complexity in providing the disclosure, not all of the examples listed below are separately and explicitly disclosed as combinable with all of the others of the examples listed below and other embodiments disclosed hereinabove. Unless one of ordinary skill in the art would understand that these examples listed below, and the above disclosed embodiments, are not combinable, it is contemplated within the scope of the disclosure that such examples and embodiments are combinable.

Example 1. A seal assembly for a high-temperature rotary kiln, the seal assembly comprising: a seal rotor couplable to the high-temperature rotary kiln such that the seal rotor is configured to rotate with the high-temperature rotary kiln; a track roller channel couplable to the seal rotor; and a seal housing comprising a seal configured to interface with the seal rotor on an external-facing side of the seal rotor such that an internal-facing side of the seal rotor is free of seal component interfaces.

Example 2. The seal assembly of Example 1, further comprising a collar configured to be attached to a rotary kiln shell of the high-temperature rotary kiln, wherein the seal rotor and the track roller channel are couplable to the high-temperature rotary kiln through the collar.

Example 3. The seal assembly of any one of Examples 1–2, wherein the seal is a rope seal.

Example 4. The seal assembly of any one of Examples 1–3, wherein the seal housing further comprises an additional seal configured to interface with the seal rotor on the external-facing side of the seal rotor.

Example 5. The seal assembly of Example 4, further comprising a fluid port in the seal housing configured to allow a fluid jet to pass through the seal housing onto the seal rotor.

Example 6. The seal assembly of Example 5, further comprising a gap between the seal and the additional seal, wherein the fluid jet creates a pressure differential between the gap and a chamber of the high-temperature rotary kiln to form a fluid seal purge for the seal assembly.

Example 7. The seal assembly of any one of Examples 1–6, wherein the seal is configured to withstand an operating temperature of up to 450 degrees Celsius.

Example 8. The seal assembly of any one of Examples 1–7, wherein the track roller channel transfers an axial load from the high-temperature rotary kiln to the seal housing to maintain a sealing force of the seal against the seal rotor.

Example 9. The seal assembly of any one of Examples 1–8, wherein the seal housing and the seal are accessible for maintenance on the external-facing side of the seal rotor without decoupling the seal rotor from the high-temperature rotary kiln.

Example 10. The seal assembly of any one of Examples 1–9, wherein the seal is configured to withstand an oxygen-rich environment of the high-temperature rotary kiln.

Example 11. An assembly comprising: a high-temperature rotary kiln comprising a rotary kiln shell forming a chamber; a seal rotor coupled to the rotary kiln shell of the high-temperature rotary kiln; and a seal housing comprising a rope seal configured to interface with the seal rotor on an external-facing side of the seal rotor such that an internal-facing side of the seal rotor is free of seal component interfaces.

Example 12. The assembly of Example 11, further comprising: a track roller channel coupled to the seal rotor; and a track roller coupled to the seal housing; wherein the track roller is in communication with the track roller channel to transfer an axial load of the high-temperature rotary kiln from the track roller channel through the track roller to the seal housing to maintain a sealing force of the rope seal against the seal rotor.

Example 13. The assembly of Example 12, further comprising a collar attached to the rotary kiln shell of the high-temperature rotary kiln, wherein the seal rotor is coupled to the rotary kiln shell of the high-temperature rotary kiln through the collar.

Example 14. The assembly of any one of Examples 11–13, wherein the seal housing further comprises an additional rope seal configured to interface with the seal rotor on the external-facing side of the seal rotor.

Example 15. The assembly of Example 14, further comprising a fluid port in the seal housing configured to allow a fluid jet to pass through the seal housing onto the seal rotor.

Example 16. The assembly of Example 15, further comprising a gap between the rope seal and the additional rope seal, wherein the fluid jet creates a pressure differential between the gap and the chamber of the high-temperature rotary kiln to form a fluid seal purge.

Example 17. The assembly of any one of Examples 11–16, wherein the rope seal is configured to withstand an operating temperature of up to 450 degrees Celsius.

Example 18. The assembly of any one of Examples 11–17, wherein the seal housing and the rope seal are accessible for maintenance on the external-facing side of the seal rotor without decoupling the seal rotor from the high-temperature rotary kiln.

Example 19. The assembly of any one of Examples 11–18, further comprising an expansion joint coupled to the seal housing, wherein the expansion joint is configured to expand and contract in an axial direction to accommodate thermal expansion of the rotary kiln shell.

Example 20. An assembly comprising: a high-temperature rotary kiln comprising a rotary kiln shell; an alignment collar attached to the rotary kiln shell of the high-temperature rotary kiln; a seal rotor coupled to the alignment collar such that the seal rotor is configured to rotate with the high-temperature rotary kiln; a seal housing comprising a first rope seal and a second rope seal, wherein the first rope seal and the second rope seal each interface with the seal rotor on an external-facing side of the seal rotor such that an internal-facing side of the seal rotor is free of seal component interfaces; a fluid port in the seal housing configured to allow a fluid jet to pass through the seal housing onto the seal rotor; and a material collection bin beneath the seal rotor to capture drop out material from the seal housing and the seal rotor.

The use in the foregoing description and in the appended claims of the terms “first,” “second,” “third,” etc., is not necessarily to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget, and not necessarily to connote that the second widget has two sides.

In the foregoing description, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention. The use of the term “some embodiments” herein is not to be construed to exclude all embodiments. For example, while a particular feature may be described herein as found in some embodiments, that particular feature may be found in all embodiments.

The present invention may be embodied in other specific forms without departing from its spirit or essential characteristics. The described embodiments are to be considered in all respects only as illustrative and not restrictive. For example, the methods described herein may be performed with fewer or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A seal assembly for a high-temperature rotary kiln, the seal assembly comprising:
a seal rotor configured to be coupled to the high-temperature rotary kiln such that the seal rotor rotates with the high-temperature rotary kiln;
a track roller channel configured to be coupled to the seal rotor; and
a seal housing comprising a seal configured to interface with the seal rotor on an external-facing side of the seal rotor such that an internal-facing side of the seal rotor is free of seal component interfaces.

2. The seal assembly of claim 1, further comprising a collar configured to be attached to a rotary kiln shell of the high-temperature rotary kiln, wherein the seal rotor and the track roller channel are configured to be coupled to the high-temperature rotary kiln through the collar.

3. The seal assembly of claim 1, wherein the seal is a rope seal.

4. The seal assembly of claim 1, wherein the seal housing further comprises an additional seal configured to interface with the seal rotor on the external-facing side of the seal rotor.

5. The seal assembly of claim 4, further comprising a fluid port in the seal housing configured to allow a fluid jet to pass through the seal housing onto the seal rotor.

6. The seal assembly of claim 5, further comprising a gap between the seal and the additional seal, wherein the fluid jet creates a pressure differential between the gap and a chamber of the high-temperature rotary kiln to form a fluid seal purge for the seal assembly.

7. The seal assembly of claim 1, wherein the seal is configured to withstand an operating temperature of up to 450 degrees Celsius.

8. The seal assembly of claim 1, wherein the track roller channel transfers an axial load from the high-temperature rotary kiln to the seal housing to maintain a sealing force of the seal against the seal rotor.

9. The seal assembly of claim 1, wherein the seal housing and the seal are accessible for maintenance on the external-facing side of the seal rotor without decoupling the seal rotor from the high-temperature rotary kiln.

10. The seal assembly of claim 1, wherein the seal is configured to withstand an oxygen-rich environment of the high-temperature rotary kiln.

11. An assembly comprising:
a high-temperature rotary kiln comprising a rotary kiln shell forming a chamber;
a seal rotor coupled to the rotary kiln shell of the high-temperature rotary kiln; and
a seal housing comprising a rope seal configured to interface with the seal rotor on an external-facing side of the seal rotor such that an internal-facing side of the seal rotor is free of seal component interfaces.

12. The assembly of claim 11, further comprising:
a track roller channel coupled to the seal rotor; and
a track roller coupled to the seal housing;
wherein the track roller is in communication with the track roller channel to transfer an axial load of the high-temperature rotary kiln from the track roller channel through the track roller to the seal housing to maintain a sealing force of the rope seal against the seal rotor.

13. The assembly of claim 12, further comprising a collar attached to the rotary kiln shell of the high-temperature rotary kiln, wherein the seal rotor is coupled to the rotary kiln shell of the high-temperature rotary kiln through the collar.

14. The assembly of claim 11, wherein the seal housing further comprises an additional rope seal configured to interface with the seal rotor on the external-facing side of the seal rotor.

15. The assembly of claim 14, further comprising a fluid port in the seal housing configured to allow a fluid jet to pass through the seal housing onto the seal rotor.

16. The assembly of claim 15, further comprising a gap between the rope seal and the additional rope seal, wherein the fluid jet creates a pressure differential between the gap and the chamber of the high-temperature rotary kiln to form a fluid seal purge.

17. The assembly of claim 11, wherein the rope seal is configured to withstand an operating temperature of up to 450 degrees Celsius.

18. The assembly of claim 11, wherein the seal housing and the rope seal are accessible for maintenance on the external-facing side of the seal rotor without decoupling the seal rotor from the high-temperature rotary kiln.

19. The assembly of claim 11, further comprising an expansion joint coupled to the seal housing, wherein the expansion joint is configured to expand and contract in an axial direction to accommodate thermal expansion of the rotary kiln shell.

20. An assembly comprising:
a high-temperature rotary kiln comprising a rotary kiln shell;
an alignment collar attached to the rotary kiln shell of the high-temperature rotary kiln;
a seal rotor coupled to the alignment collar such that the seal rotor is configured to rotate with the high-temperature rotary kiln;
a seal housing comprising a first rope seal and a second rope seal, wherein the first rope seal and the second rope seal each interface with the seal rotor on an external-facing side of the seal rotor such that an internal-facing side of the seal rotor is free of seal component interfaces;
a fluid port in the seal housing configured to allow a fluid jet to pass through the seal housing onto the seal rotor; and
a material collection bin beneath the seal rotor to capture drop out material from the seal housing and the seal rotor.
